(19) United States
(12) Patent Application Publication
(10) Pub. No.: US 2002/0133492 A1
(43) Pub. Date: Sep. 19, 2002

(54) System and methods for web browser based document scanning, remote storage, and retrieval

(75) Inventors: Michael A. Goldstein, Purchase, NY (US); Issac I. Rubinstein, Tenafly, NJ (US)

Correspondence Address: GREENBERG-TRAURIG, 1750 TYSONS BOULEVARD, 12TH FLOOR, MCLEAN, VA, 22102, US

(73) Assignee: Samson Information Tech, L.L.C., Mamaroneck, NY

(21) Appl. No.: 09/988,069

(22) Filed: Nov. 16, 2001

Related U.S. Application Data
(60) Provisional application No. 60/248,840, filed on Nov. 16, 2000.

(51) Int. Cl. G06F 7/00

(52) U.S. Cl. 707/10

(57) ABSTRACT

A computer network or Internet based system that enables users to scan documents and store those documents in a secure, remote location for later retrieval and use. The system includes software which allows users to store a document from within a web browser without the use of plug-in software, scan paper documents and store the scanned files for later access and retrieval. The system also includes software which enables the user to create and control security and access to the documents, thereby enabling groups of users to share access to the stored documents yet still control the removal, editing and access abilities of the group members. Moreover, the disclosed system includes a unique Temporary Transfer Buffer file security system to protect the stored files from unauthorized access.

This application claims priority from Provisional U.S. patent application Ser. No. 60/248,840 filed Nov. 16, 2000 which is hereby incorporated by reference in its entirety.

### FIELD OF THE INVENTION

The present invention relates to the field of electronic document management, and more specifically it relates to the fields of document imaging and remote file storage and accessibility.

### BACKGROUND OF THE INVENTION

The Internet is changing the way software is created, used, and distributed. Applications, previously available only as a purchased product, are now available as services on the Internet and are often referred to as Net-Services. Net-Services are mobile, accessible from any web browser, inexpensive, and easy to use.

As business owners, home or small office users, and other PC users become even more mobile the need to stay connected and have access to information and data becomes paramount. However, most of these users leave their key data trapped in their desktop computer, paper filing systems, or in and around their office.

The present invention addresses these and other problems related to remote access and storage of data files.

### SUMMARY OF THE INVENTION

The present invention provides a system for enabling users to store documents from within a web browser and store those documents in a secure, remote location on a computer network such as the Internet. Users will also be able to scan paper documents and store the scanned files in a secure, remote location.

As part of the system, users will be able to create and control security and access to the documents. Therefore, groups of users will be able to share the stored documents yet the removal, editing and access to certain files can be restricted among the users.

Therefore, the present invention provides a Net-Services application which enable users to scan, save and store files in a remote location and then provide a secure system for remote access to the stored documents.

### BRIEF DESCRIPTION OF THE DRAWINGS

FIG. 1 is a block diagram illustrating high-level software and hardware modules used on a client machine when scanning documents while online.

FIG. 2 is a block diagram illustrating high-level software and hardware modules used on a client machine when scanning documents while offline, as well as a procedure for moving offline files into an online repository.

FIG. 3 is a block diagram illustrating a folder and directory hierarchy used by the present invention when organizing files.

FIG. 4 is a block diagram illustrating a preferred server software architecture.

FIG. 5 is a block diagram illustrating file security attributes which are associated with files stored by the present invention.

FIG. 6 is a block diagram illustrating a method by which annotations may be created and saved in a preferred embodiment of the present invention.

FIG. 7 is a block diagram illustrating a method by which annotations may be retrieved and displayed in a preferred embodiment of the present invention.

FIG. 8 is a block diagram illustrating a process by which files may be uploaded to a server.

FIG. 9 is a block diagram of a conventional Proxy Server file security configuration.

FIG. 10 is a block diagram of an isolated transfer buffer file security configuration for use in a preferred embodiment of the present invention.

### DETAILED DESCRIPTION OF THE PREFERRED EMBODIMENT

Reference is now made in detail to the preferred embodiments of the present invention, examples of which are illustrated in the accompanying drawings.

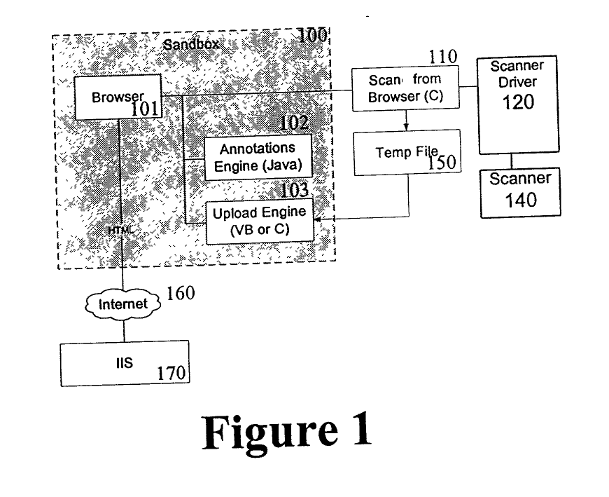

FIG. 1 is a block diagram illustrating high-level software and hardware modules used on a client machine to scan documents while online. Scanner 140 represents a scanner, digital camera, or other TWAIN, or a successor or replacement standard, compatible device attached to a user computer. Scanner 140 can be used to create an electronic image to be stored by the present invention. Scanner Driver 120 represents standards-based software which allows Scan from Browser 110 to access images captured by Scanner 140.

Scan from Browser 110 represents software written in C, Visual Basic, or other high-level programming language. Scan from Browser 110 includes procedures and modules, which allow software within Sandbox 100 to access the standards-based driver 120. The Scan from Browser 110 provides users with a scanning functionality from any personal computer (PC).

Sandbox 100 represents a typical sandbox, which is a programming technique that prevents software running inside a sandbox from carrying out potentially dangerous activities, such as directly reading from or writing to a hard-drive. An application wishing to access information outside the sandbox may request that information from other software already installed on a computer.

In addition to the ability to scan directly through the web browser, the present invention will be able to display Tagged Image File Format (TIFF) directly in the browser without additional plug-in software. TIFF images are an efficient way to store black and white images of business documents. Standard browsers cannot display TIFF images without the help of plug-in software application. The present invention enables users to display scanned images in any standard browser and thus presents users with a truly portable solution.

A web-based application is truly portable only when every function can be performed from any browser. Mobile workers do not always have full control over their web browsers. Sometimes, when using an occasional computer such as at an airport service center or a public data kiosk, plug-in installations are not available. Even when a plug-in installation is technically possible, it is not always an easy task to accomplish. Installation of a plug-in is a sophisticated process that can cause conflicts with other plug-ins or software already existing on a specific computer.

Sandbox 100 allows portions of the present invention to be downloaded via Internet 160 or other communications medium and run from within a web browser. Sandbox 100 further allows such software to interact with Scan from Browser 110, Temp File 150, and other portions of the present invention.

Temp File 150 represents a file or set of files which is created as a document and is scanned by Scanner 140. Upload Engine 103 can transmit Temp File 150 to the server portion of the present invention, represented by 11S 170, via Browser 101 and Internet 160. In addition, Annotations Engine 102 may request document information, such as a file name, keywords describing a file, author name, and other such information.

Browser 101 represents a typical World Wide Web browser (“Web Browser”), such as Internet Explorer, manufactured by Microsoft of Seattle, Washington, or Netscape Navigator, manufactured by Netscape of Mountain View, California. Browser 101 may be used to present information to or solicit responses from a user, upload or download files, and for other purposes.

IIS 170 represents a standard World Wide Web server (“web server”). A web server may be a program running on a single computer, or a collection of programs running on separate computers, which may deliver content from one or more sources to a web browser. Examples of standard web servers include Internet Information Server, developed by Microsoft Corporation of Redmond, Calif.; Enterprise Server, developed by Netscape Corporation, of Mountain View, Calif.; and Apache Server, developed by The Apache Software Foundation of Lincoln, Nebr.

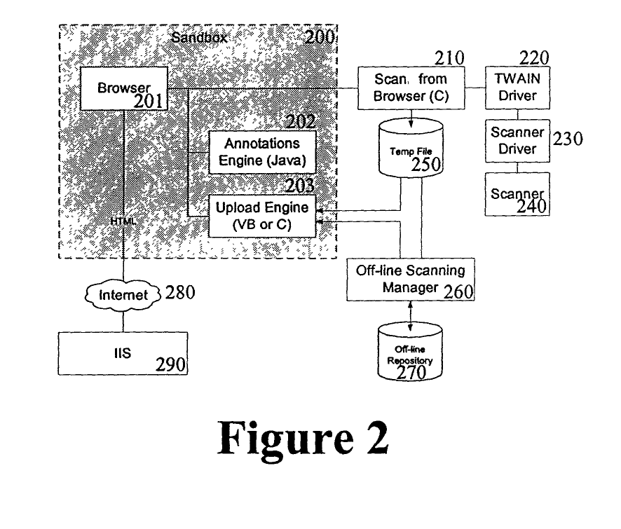

FIG. 2 is a block diagram illustrating high-level software and hardware modules used on a client machine when scanning documents while offline. A comparison of FIG. 1 and FIG. 2 highlights many of the differences when operating offline. Instead of transmitting Temp File 250 to IIS 290 as may be done when the present invention is online, scanned images may be stored on the local machine. Images may be stored as individual files, or images may be stored in a database, as illustrated by Off-line Repository 270.

Off-line Scanning Manager 260 can coordinate storing images in Off-line Repository 270. Off-line Scanning Manager 260 may also store annotations from Annotations Engine 202 in Off-line Repository 270.

If files exist locally that have not been transmitted to 11S 290, Off-line Scanning Manager may establish a connection with IIS 290 through Browser 201 and Upload Engine 203. A connection may be automatically established, or a user may be asked to interact with the present invention prior to initiating an upload.

For off-line operation the sandbox 200, browser 210, and Internet 280 operate as described in FIG. 1. Also shown for off-line operation is the scanner 240, scanner driver 230 and a separate TWAIN driver 220.

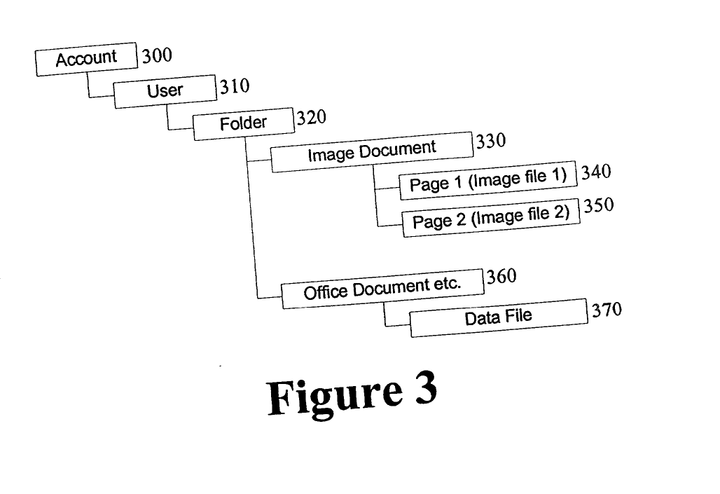

FIG. 3 is a block diagram illustrating a folder, document, and file hierarchy used by the present invention when organizing scanned images. A folder, document, and file hierarchy may be implemented on a server, and a similar folder and directory hierarchy may be implemented on a local computer. As new accounts are created, folders with appropriate permissions may be created for each account, as illustrated by Account 300. Individual users authorized to access files within an account may have their own folders within an account folder, as illustrated by User 310. Users may organize documents by creating sub-folders within a user folder, as illustrated by Folder 320.

When a user transmits a data file to the present invention, a new folder may be created to house the transmitted file. In addition, as the first image in a set of image files associated with a document, such as the individual pages of a book, are transmitted to the present invention, a new folder may be created in which the individual image files are stored. Folders containing data or image files will be referred to as “documents” for the purposes of the present application. As depicted in FIG. 3, an Image document 330 may contain individual image files 340, 350 and a data file or Office Document 360 may contain a data file 370.

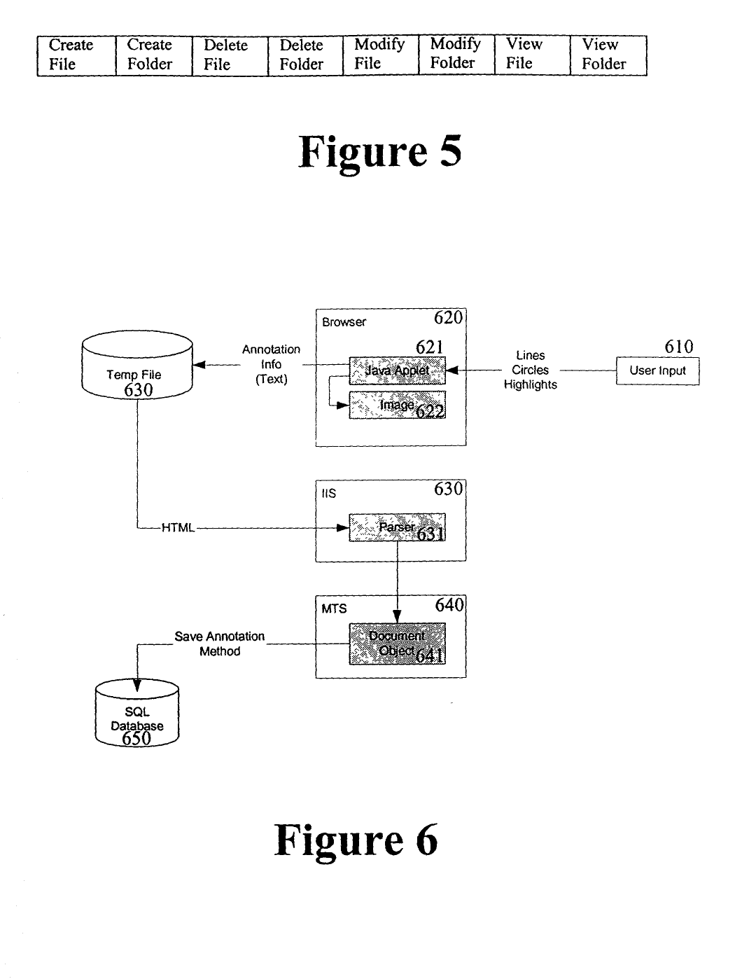

Multiple attributes may be associated with each folder or file created. Such attributes may include security information, illustrated in more detail in the following text and in FIG. 5; hierarchy level; document or folder name; creation date; and other such information.

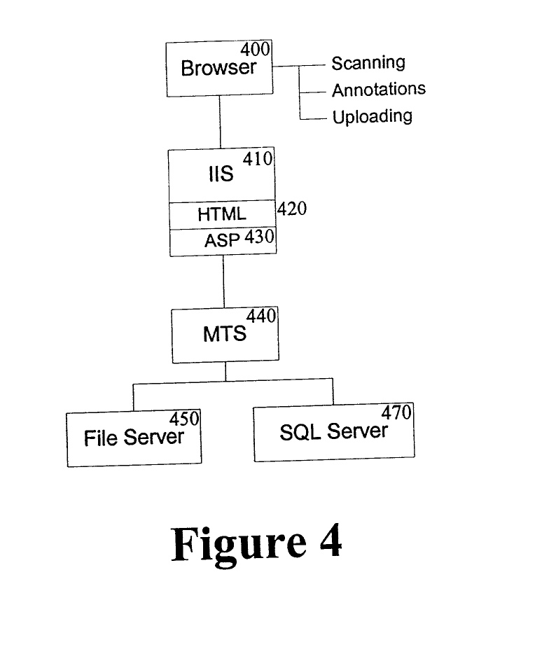

FIG. 4 is a block diagram illustrating a preferred server software architecture. When a document is stored in or retrieved from File Server 450, file and folder attributes may be stored in or retrieved from SQL Server 470. MTS 440 may verify user permissions prior to allowing documents to be stored or retrieved.

The server architecture illustrated in FIG. 4 also allows a user to quickly search for specific documents or files. When a user wishes to search for a document or file, Browser 400 may be used to submit a search request to IIS 410, which is a web server. IIS 410 may transmit a search request to MTS 440, which in turn may relay the request to SQL Server 470. SQL Server 470 may return a list of documents or files with attributes matching those requested by a user, as well as a link to the location of such documents or files. MTS 440 may in turn transmit the list of documents or files returned by SQL Server 470 to IIS 410 through ASP 430 and HTML 420. IIS 410 may format the results for display by Browser 400. A user may then interact with such a display to view the requested documents or files.

FIG. 5 is a block diagram illustrating file security attributes which are associated with files stored by the present invention. Folders and files stored as part of the present invention may have such security attributes associated with them, and such security attributes may be stored in SQL Server 470. In a preferred embodiment, SQL Server 470 may have an associated line item in a database table for each file, as illustrated in the table below.

| User | Document | Permissions |
|---|---|---|
| 654-85-963-85 | \Jane\My Files\TestDrive\TestDrive.JPG | 11111111 |
| 113-96-852-78 | \Jane\My Files\TestDrive\TestDrive.JPG | 00000011 |
| 325-69-246-45 | \Jane\My Files\TestDrive\TestDrive.JPG | 00001111 |

As users are added to SQL Server 470, users may be assigned a unique identifier which may distinguish one user from another. Users may be required to enter a password along with their assigned unique identifier, a combination of a username and account name, or other such security information, prior to gaining access to the present invention. IIS 410 may confirm a user identity through such a security procedure and, if a user identity is confirmed, a secure, temporary identifier may be calculated by SQL Server 470.

A temporary identifier may then be transmitted from IIS 410 to Browser 400. Once a temporary identifier is calculated, Browser 400 may use such a temporary identifier rather than requiring a user to reenter a username and password or other authorization information. A temporary identifier has the added benefit of not repeatedly transmitting username, passwords, and other such authorization information, thereby decreasing the likelihood of unwanted interception of such authorization information. In a preferred embodiment, the present invention may further enhance security by causing a temporary identifier to expire after a certain period of time or a specific number of transactions, further reducing the potential impact of intercepted authorization information.

FIG. 6 is a block diagram illustrating a method by which annotations may be saved in a preferred embodiment of the present invention. The present invention makes use of a three-tier application. The first-tier, often referred to as the front-end, may consist of a Web browser-based graphical user interface, usually at a personal computer or workstation. User Input 610, which may include text, lines, circles, highlights, can be overlaid over image files, such as JPG or TIFF 622 while they are displayed in the browser 620 through use of a Java applet 621. The annotations are sent to a Temp file 630.

The middle-tier or second-tier, typically consists of business logic application or set of applications, possibly on a local area network, intranet server, or Internet Server. In this instance the annotations file is then sent to IIS 630. A program or Parser 631, usually part of the middle tier, that receives input in the form of sequential source program instructions, interactive online commands, markup tags, or some other defined interface and breaks them up into parts that can then be managed by other components. A parser, as well as a dedicated component, may also check to see that all input has been provided that is necessary.

The annotation files are then sent to the third-tier, which consists of a SQL database 650 and a Microsoft Transaction Server 640. The annotations file is converted to a document object 641 and stored on the file server 450 while information regarding the location of the file is stored in the SQL database 650.

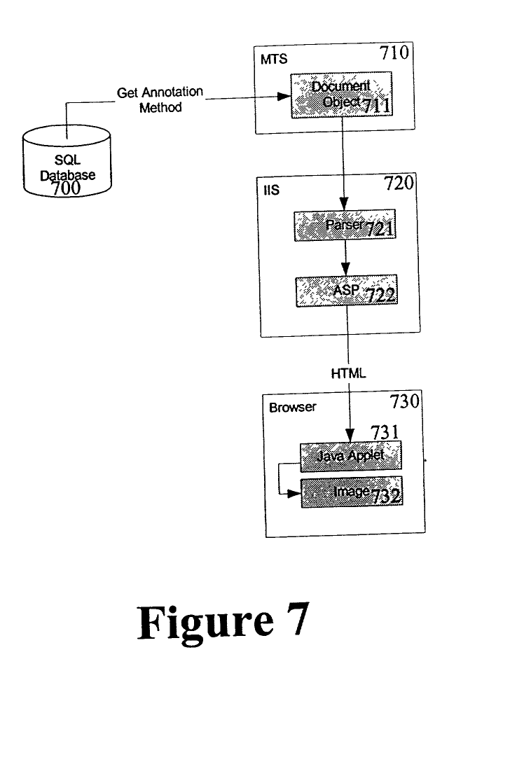

FIG. 7 is a block diagram illustrating a method by which annotations may be retrieved. Still utilizing the same three-tiered application described in relation to FIG. 6, an annotations file was saved on the file server and some related information was saved within an SQL database 700. Upon command a Microsoft Transaction Server 710 retrieves the Document Object 711. Then a related annotations file is retrieved from the file server. The annotations file is converted by parser 721 and application service provider 722 on the IIS 720 server. Using HTML the Image 732 is then overlaid with the reconstructed annotations on browser 730 through use of a JAVA applet 731.

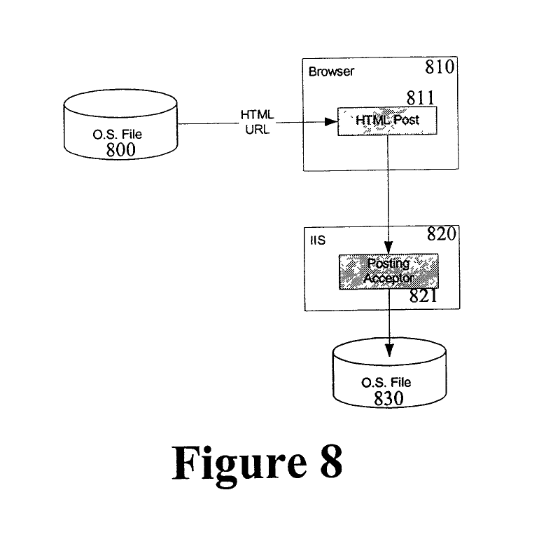

FIG. 8 is a block diagram illustrating a process by which files may be uploaded to a server. An O.S. File 800 may be uploaded onto a local browser 810 using HTML Post 811. The file is then conveyed to IIS 820 server and to a Posting Acceptor 821. The file is then saved as an O.S. File 830 on the system of the present invention.

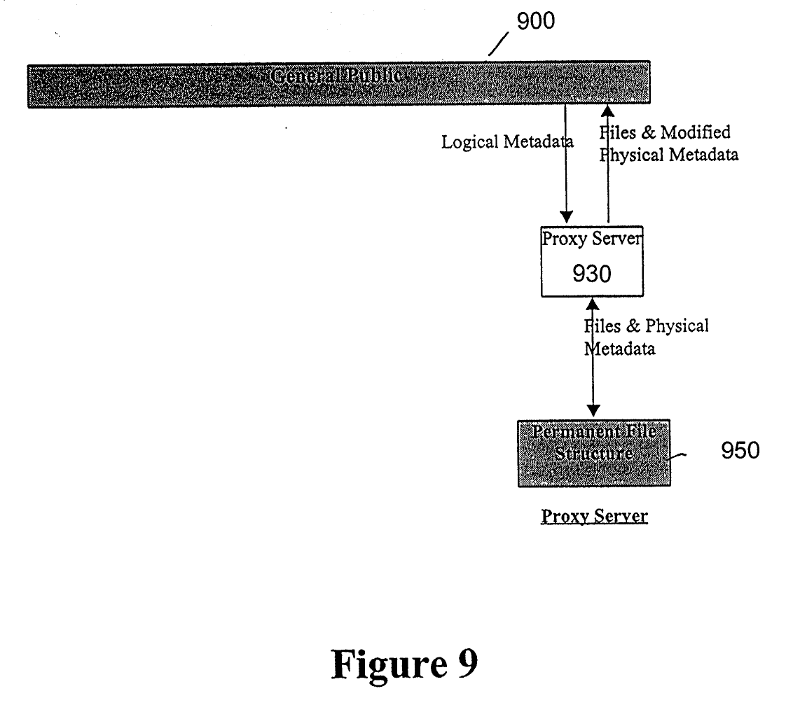

FIG. 9 depicts a block diagram of a conventional proxy server system security configuration. As evident form FIG. 9, the General Public 900 communicates with Proxy Server 930 through Logical Metadata. The Proxy Server 930 retrieves Files & Physical Metadata from a Permanent File Structure 950. The Proxy Server 930 then communicates the Files & Modified Physical Metadata 920 to the General Public 900. In conventional proxy server configurations the Permanent File Structure 950 is shielded to enhanced security and all communications must pass through an additional device, which slows down repeated downloads. The system security is ultimately dependent upon the Proxy Server quality. Further, any proxy server security bridge creates a security exposure for the system because the same hacking technique could be used to expose the permanent file system.

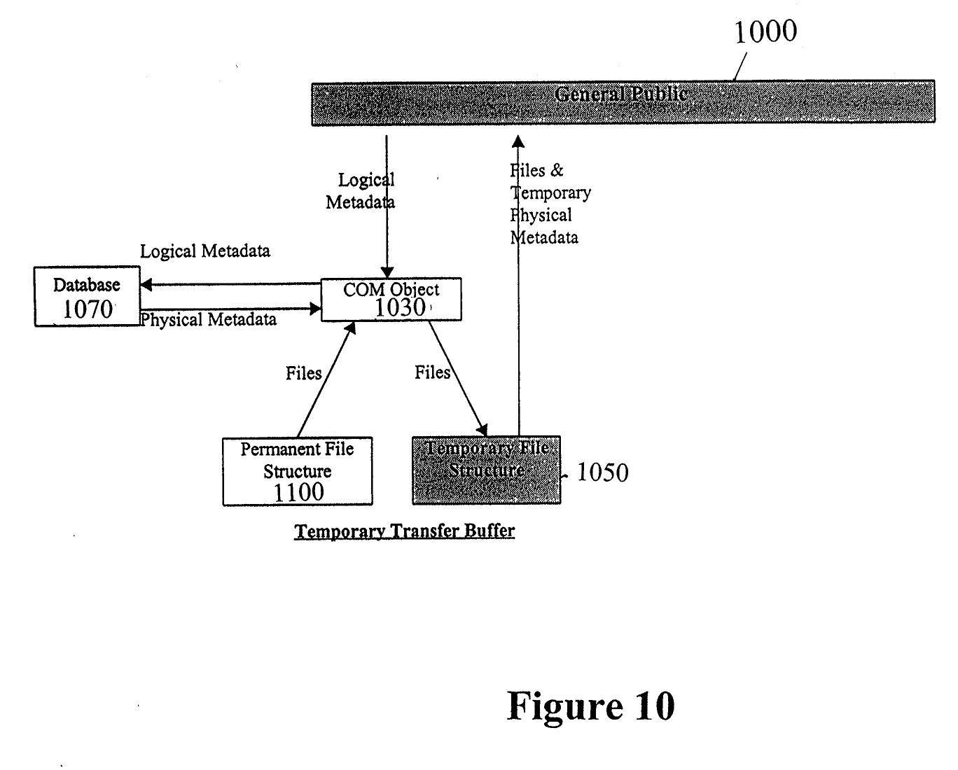

FIG. 10 depicts a block diagram of a Temporary Transfer Buffer file access security configuration of the present invention. The Temporary Transfer Buffer provides a system where the Permanent File Structure 1100 is never exposed to the General Public 1000 in any encrypted or secured way and is not even exposed to authorized logged on users of the present invention. Further, all repeated communications are to the temporary file server or Temporary File Structure 1050 depicted in FIG. 10. In addition, sensitive information is never placed on any public device, eliminating the need to secure the file system. The Temporary Transfer buffer contains a database 1070 which stores and sends Logical Metadata and Physical Metadata to the COM Object 1030. The Permanent File Structure 1100 communicates with the COM Object 1030. The COM Object 1030 also receives Logical Metadata from the General Public 1000 and transfers files to the Temporary File Structure 1050. The General Public 1000 has access to the Files and Temporary Physical Metadata 1020 though the Temporary File Structure 1050 and thereby protects the security of the Permanent File Structure 1100.

While the preferred embodiment and various alternative embodiments of the invention have been disclosed and described in detail herein, it may be apparent to those skilled in the art that various changes in form and detail may be made therein without departing from the spirit and scope thereof

What is claimed is:

1. A system for providing remote access to documents over a computer network comprising;
a client computer;
scan software running on the client computer providing an interface to an input device;
a web browser operating within the client computer;
an upload engine under the control of the browser for receiving a document from an input device;
an annotations engine under the control of the browser for accessing the document received by the upload engine; and
a web server for remote storage of the received document.

2. The system of claim 1 wherein the input device is a document scanner, digital camera or other TWAIN compatible device.

3. The system of claim 1 wherein document security is provided by the formation of a temporary working file formed by logical and physical metadata from the web server.

4. A method providing remote access to document over a computer network comprising the steps of:
providing a client computer;
running scan software on the client computer thereby providing an interface to input devices;
operating a web browser within the client computer;
receiving a document as input to an upload engine under the control of the browser;
accessing the document via an annotations engine under control of the browser; and
storing the received document in a web server.

5. The method of claim 4 wherein the input device is received from a TWAIN compatible device.

6. The system of claim 4 wherein the security of the document is provided by the formation of a temporary working file using logical and physical metadata from the web server.

7. A computer readable medium encoded with a set of executable instructions to perform a method for web browser based document scanning, remote storage and retrieval, the method comprising:
interfacing with input devices;
operating a web browser within a client computer;
receiving a document from an input device to an upload engine under the control of the browser;
accessing the document via an annotations engine under control of the browser; and
storing the received document in a web server.
